(19) United States
(12) Patent Application Publication
(10) Pub. No.: US 2011/0161099 A1
(43) Pub. Date: Jun. 30, 2011

(54) Low-cost method for reducing rates of side effects from using drugs, healing substances and medical procedures

(76) Inventor: Igor Igorevich Stukanov, Toronto (CA)

(21) Appl. No.: 12/807,477

(22) Filed: Sep. 8, 2010

Related U.S. Application Data
(60) Provisional application No. 61/284,850, filed on Dec. 28, 2009.

(51) Int. Cl. G06Q 50/00; G06Q 90/00

(52) U.S. Cl. 705/2; 705/500

(57) ABSTRACT

A low-cost method for reducing rates of side effects from using drugs, healing substances and medical procedures, by means of segmentation of parameters related to the treatment procedure and healing processes in the body of humans or animals and using results of available clinical trials.

### CROSS-REFERENCE TO RELATED APPLICATIONS

This application claims priority status of the provisional patent application 61/284,850 filed on Dec. 28, 2009

### STATEMENT REGARDING FEDERALLY SPONSORED RESEARCH OR DEVELOPMENT

Not applicable.

### REFERENCE TO A MICROFICHE APPENDIX Not applicable.

### BACKGROUND OF THE INVENTION

1. Field of the Invention

This invention relates to a method, which allow reduce rates of side effects in humans or animals from using drugs, healing substances, or medical procedures.

2. Background Information

Currently there are two main approaches to reduce rate of side effects from using drugs.

The first approach consists in trying different variations of drugs until the desired rate of side effect will be reached. For example, a patent application N 20080126117 describes a method of optimization of a medication therapy regimen by removing or replacing medications. The main problem with this approach is very high cost, because clinical trials are needed for different medications.

The second approach consists in modification of existing therapeutic treatments. For example, a patent application N 20080260825 describes a method and compositions for reductions of side effects of therapeutic treatments, where nicotinic receptor modulator to reduce or eliminate a side effect associated with dopaminergic agent treatment is used. Such types of methods are less costly than in the first approach, but require a lot of research to determine which modifications to test in clinical trials. And because cost of research is high such methods also are high-cost methods

The purpose of the current invention is to suggest low-cost method, which is described below.

### BRIEF SUMMARY OF THE INVENTION

A low cost method for reducing rates of side effects from using drugs, healing substances and medical procedures is proposed. The method segments a set of variables affecting efficiency of a medical treatment and determines segments with minimal or acceptable rates of side effects.

### BRIEF DESCRIPTION OF THE SEVERAL VIEWS OF THE DRAWINGS

Not applicable.

### DETAILED DESCRIPTION OF THE INVENTION

The present invention is directed to a low-cost method, which allows reducing rates of side effects in medical treatments of human or animals and is described below in a one example.

### Example 1

Five clinical trials for testing of a drug X to treat disease Y were conducted, with the following results. In the first trial 218 patients were involved and 40 cases with side effects were observed. In the second trial 156 patients were involved and 24 cases with side effects were observed. In the third trial 149 patients were involved and 27 cases with side effects were observed. In the forth trial 229 patients were involved and 34 cases with side effects were observed. In the fifth trial 177 patients were involved and 33 cases with side effects were observed.

The panel of experts determined the segmentation parameters as blood type (BT) and glycemic index (GI). Glycemic index values were partitioned into three groups. The first group with GI values less or equal 55 was called low value group. The second group with GI values from 56 to 69 was called medium value group. The third group with GI values more or equal 77 was called high value group. Therefore, twelve segments were defined based on four groups of BT and three group of GI. For each segment, the rate of side effect was recalculated based on existing data from the clinical trials. The results are shown below.

### Clinical Trial 1

Segment 1 (BT=A, GI=Low) Number of Participants=14 Number of cases with side effects=4

Segment 2 (BT=B, GI=Low) Number of Participants=19 Number of cases with side effects=5

Segment 3 (BT=AB, GI=Low) Number of Participants=17 Number of cases with side effects=5

Segment 4 (BT=O, GI=Low) Number of Participants=18 Number of cases with side effects=5

Segment 5 (BT=A, GI=Medium) Number of Participants=22 Number of cases with side effects=0

Segment 6 (BT=B, GI=Medium) Number of Participants=24 Number of cases with side effects=0

Segment 7 (BT=AB, GI=Medium) Number of Participants=27 Number of cases with side effects=0

Segment 8 (BT=O, GI=Medium) Number of Participants=21 Number of cases with side effects=6

Segment 9 (BT=A, GI=High) Number of Participants=13 Number of cases with side effects=3

Segment 10 (BT=B, GI=High) Number of Participants=14 Number of cases with side effects=4

Segment 11 (BT=AB, GI=High) Number of Participants=18 Number of cases with side effects=5

Segment 12 (BT=O, GI=High) Number of Participants=11 Number of cases with side effects=3

### Clinical Trial 2

Segment 1 (BMA, GI=Low) Number of Participants=11 Number of cases with side effects=2

Segment 2 (BT=B, GI=Low) Number of Participants=17 Number of cases with side effects=4

Segment 3 (BT=AB, GI=Low) Number of Participants=16 Number of cases with side effects=4

Segment 4 (BT=O, GI=Low) Number of Participants=15 Number of cases with side effects=3

Segment 5 (BT=A, GI=Medium) Number of Participants=12 Number of cases with side effects=0

Segment 6 (BT=B, GI=Medium) Number of Participants=14 Number of cases with side effects=0

Segment 7 (BT=AB, GI=Medium) Number of Participants=17 Number of cases with side effects=0

Segment 8 (BT=O, GI=Medium) Number of Participants=13 Number of cases with side effects=3

Segment 9 (BT=A, GI=High) Number of Participants=7 Number of cases with side effects=1

Segment 10 (BT=B, GI=High) Number of Participants=9 Number of cases with side effects=2

Segment 11 (BT=AB, GI=High) Number of Participants=14 Number of cases with side effects=3

Segment 12 (BT=O, GI=High) Number of Participants=11 Number of cases with side effects=2

### Clinical Trial 3

Segment 1 (BT=A, GI=Low) Number of Participants=9 Number of cases with side effects=2

Segment 2 (BT=B, GI=Low) Number of Participants=13 Number of cases with side effects=3

Segment 3 (BT=AB, GI=Low) Number of Participants=17 Number of cases with side effects=4

Segment 4 (BT=O, GI=Low) Number of Participants=15 Number of cases with side effects=4

Segment 5 (BT=A, GI=Medium) Number of Participants=7 Number of cases with side effects=0

Segment 6 (BT=B, GI=Meditun) Number of Participants=16 Number of cases with side effects=0

Segment 7 (BT=AB, GI=Medium) Number of Participants=13 Number of cases with side effects=0

Segment 8 (BT=O, GI=Medium) Number of Participants=16 Number of cases with side effects=4

Segment 9 (BT=A, GI=High) Number of Participants=6 Number of cases with side effects=1

Segment 10 (BT=B, GI=High) Number of Participants=14 Number of cases with side effects=3

Segment 11 (BT=AB, GI=High) Number of Participants=11 Number of cases with side effects=3

Segment 12 (BT=O, GI=High) Number of Participants=12 Number of cases with side effects=3

### Clinical Trial 4

Segment 1 (BT=A, GI=Low) Number of Participants=7 Number of cases with side effects=1

Segment 2 (BT=B, GI=Low) Number of Participants=19 Number of cases with side effects=4

Segment 3 (BT=AB, GI=Low) Number of Participants=17 Number of cases with side effects=3

Segment 4 (BT=O, GI=Low) Number of Participants=26 Number of cases with side effects=5

Segment 5 (BT=A, GI=Medium) Number of Participants=9 Number of cases with side effects=0

Segment 6 (BT=B, GI=Medium) Number of Participants=24 Number of cases with side effects=0

Segment 7 (BT=AB, GI=Medium) Number of Participants=27 Number of cases with side effects=0

Segment 8 (BT=O, GI=Medium) Number of Participants=31 Number of cases with side effects=7

Segment 9 (BT=A, GI=High) Number of Participants=13 Number of cases with side effects=2

Segment 10 (BT=B, GI=High) Number of Participants=14 Number of cases with side effects=3

Segment 11 (BT=AB, GI=High) Number of Participants=18 Number of cases with side effects=4

Segment 12 (BT=O, GI=High) Number of Participants=24 Number of cases with side effects=5

### Clinical Trial 5

Segment 1 (BT=A, GI=Low) Number of Participants=12 Number of cases with side effects=3

Segment 2 (BT=B, GI=Low) Number of Participants=17 Number of cases with side effects=5

Segment 3 (BT=AB, GI=Low) Number of Participants=14 Number of cases with side effects=4

Segment 4 (BT=O, GI=Low) Number of Participants=14 Number of cases with side effects=4

Segment 5 (BT=A, GI=Medium) Number of Participants=18 Number of cases with side effects=0

Segment 6 (BT=B, GI=Medium) Number of Participants=19 Number of cases with side effects=0

Segment 7 (BT=AB, GI=Medium) Number of Participants=16 Number of cases with side effects=0

Segment 8 (BT=O, GI=Medium) Number of Participants=16 Number of cases with side effects=4

Segment 9 (BT=A, GI=High) Number of Participants=11 Number of cases with side effects=3

Segment 10 (BT=B, GI=High) Number of Participants=13 Number of cases with side effects=3

Segment 11 (BT=AB, GI=High) Number of Participants=18 Number of cases with side effects=5

Segment 12 (BT=O, GI=High) Number of Participants=9 Number of cases with side effects=2

From the segmentation above we see that segments 5,6, and 7 do not have side effects in all trials. Therefore, for patients with blood types A,B, AB and glycemic index from 56 to 69, a rate of side effects from using drug X should be minimal.

1. A low-cost method for reducing rates of side effects from using drugs, healing substances, and medical procedures for medical treatments of humans or animals, comprising the following steps:
a. segmentation parameters affecting efficiency of the medical treatment are determined by experts
b. a partition of a parametric set defined by the segmentation parameters is determined by the experts
c. for each segment defined by the partition, a number of side effects is calculated based on the available results of clinical trials
d. segments with minimal rate of side effects are selected, which define category of patients for which this treatment has minimal rate of side effects.

2. A method as in claim 1, where instead of segments with minimal rate of side effects segments with minimal rate of side effects and maximal efficiency are selected.

3. A method as in claim 1, where instead of segments with minimal rate of side effects segments with maximal efficiency and limited rate of side effects are selected.

4. A method as in claim 1, where instead of segments with minimal rate of side effects segments with defined by the experts criteria are selected.

5. A method as in claim 1, where segmentation parameters and partition are selected by a computer program, based on a supplied set of variables.
